(19) United States
(12) Patent Application Publication
(10) Pub. No.: US 2026/0111964 A1
(43) Pub. Date: Apr. 23, 2026

(54) METHOD AND SYSTEM FOR TRAINING AND FINE-TUNING LARGE LANGUAGE MODELS IN GENERATING STOCK RATINGS PREDICTIONS

(71) Applicant: JPMorgan Chase Bank, N.A., New York, NY (US)

(72) Inventors: Kassiani PAPASOTIRIOU, New York, NY (US); Srijan SOOD, New York, NY (US); Tucker Richard BALCH, Suwanee, GA (US); Manuela VELOSO, New York, NY (US); Shayleen REYNOLDS, New York, NY (US)

(73) Assignee: JPMorgan Chase Bank, N.A., New York, NY (US)

(21) Appl. No.: 19/061,357

(22) Filed: Feb. 24, 2025

(30) Foreign Application Priority Data
Oct. 21, 2024 (GR) 20240100739

(51) Int. Cl. G06Q 40/06; G06Q 40/04

(52) U.S. Cl. CPC G06Q 40/06; G06Q 40/04

(57) ABSTRACT

A method and system for generating a stock rating prediction by a large language model (LLM) may be provided. The method may include constructing a prompt for the LLM based on a prompt technique with a specified task comprising a prediction task regarding a stock rating, and obtaining a plurality of stock market data. The method may also include generating at least one dataset from the plurality of stock market data for input into the LLM, and performing an inference of the at least one dataset by the LLM based on the constructed prompt with the specified task. The method may also include generating a prediction response comprising the stock rating prediction based on a result of the performing the inference by the LLM.

### CROSS-REFERENCE TO RELATED APPLICATIONS

This application claims priority benefit from Greece application No. 20240100739, filed on Oct. 21, 2024 in the Greek Patent Office, which is hereby incorporated by reference in its entirety.

### FIELD OF THE DISCLOSURE

This technology generally relates to methods and systems for training and fine-tuning large language models in generating stock ratings predictions.

### BACKGROUND INFORMATION

Investment analytics is a cornerstone of the financial services industry. Traditional stock rating methods rely heavily on the expertise of financial analysts and face several challenges such as data overload, inconsistencies in filings, and delayed reactions to market events. The rapid integration of advanced machine learning techniques, particularly Large Language Models (LLMs), presents opportunities to enhance the equity stock rating process. However, the use of LLMs in investment analytics to make investment predictions face several challenges.

For instance, to make accurate predictions, the LLMs would need to be trained on a wide variety of relevant datasets. However, the data format of these diverse dataset can vastly differ from one dataset to another, thus making it difficult for the LLMs to ingest and be trained on the diverse datasets given the LLMs' context length limitations, difficulties with tabular and numerical data, and the risk of generating inaccurate responses. That is, there are training and computational bottlenecks associated with the LLMs in making accurate investment analytic predictions. As such, these challenges prevent the LLMs from efficiently generating accurate responses to queries regarding market or investment matters.

Accordingly, there is a need for techniques to fine-tune LLMs in stock market predictions.

### SUMMARY

The present disclosure, through one or more of its various aspects, embodiments, and/or specific features or sub-components, provides, inter alia, various systems, servers, devices, methods, media, programs, and platforms for fine-tuning large language models in predicting stock ratings.

According to an aspect of the present disclosure, a method for generating a stock rating prediction by a large model language model may be provided. The method may be implemented by at least one processor. The method may include constructing a prompt for the large language model (LLM) based on a prompt technique with a specified task that may include a prediction task regarding a stock rating, and obtaining a plurality of stock market data. The method may also include generating at least one tabular dataset from the plurality of stock market data for input into the LLM, performing an inference of the at least one tabular dataset by the LLM based on the constructed prompt with the specified task, and generating a prediction response that may include the stock rating prediction based on a result of the performing the inference by the LLM.

The plurality of stock market data may include a company name, a company ticker, a date, at least one financial news comprising raw financial news data and at least one financial news summary, at least one of financial news summary sentiment, at least one of a historical return, and at least one of a financial fundamental

The LLM may include a predetermined limited token window value.

The constructing the prompt for the LLM based on the prompt technique may include chain-of-thought prompting process by: training initially the LLM with an initial set of the plurality of stock market data up to a predetermined timepoint that prevents information leakage of the LLM. The process may also include generating tabular data of the plurality of stock market data based on the at least one financial news summary and the at least one of financial news summary sentiment for input into the LLM. The process may also include performing an in-context learning process for the LLM with the tabular data, and conducting a chain-of-verification process for the LLM to check for hallucination by the LLM.

The generating the prediction response may include generating a rating score for the stock rating. The rating score may include at least one from among a strong sell score, a moderate sell score, a hold score, a moderate buy score, and a strong buy score.

The method may further include determining an accuracy of the generated prediction response based on computing a forward return for a company, and comparing the forward return of the company with at least one respective forward return of at least one other company operating within a similar sector as represented by sector quintiles.

The generating the at least one dataset may include: filtering out data that is unrelated to a company associated with the specified task by a pre-processing LLM. The generating the at least one dataset may also include summarizing the plurality of stock market data that is unfiltered by the pre-processing LLM. The summarizing may include compiling a company information, a prediction date, the at least one financial news summary, the at least one of a historical return, and the at least one of a financial fundamental with ground-truth forward return quintiles of a company. The generating the at least one dataset may also include providing the summarized plurality of stock market data from the pre-processing LLM as the input into the LLM.

The method may also include training further the LLM with a dataset comprising training data and validation data to perform the inference, and fine-tuning the LLM based on a predetermined low-rank adaptation technique comprising an injection of at least one predetermined low-rank matrix into a transformer layer of the LLM.

According to another embodiment, a computing apparatus for generating a stock rating prediction by a large model language model may be provided. The computing apparatus may include: a processor; a memory; a display; and a communication interface coupled to each of the processor, the memory, and the display.

The processor may be configured to construct a prompt for the large language model (LLM) based on a prompt technique with a specified task comprising a prediction task regarding a stock rating, and obtain a plurality of stock market data. The processor may also be configured to generate at least one dataset from the plurality of stock market data for input into the LLM, perform an inference of the at least one dataset by the LLM based on the constructed prompt with the specified task, and generate a prediction response comprising the stock rating prediction based on a result of the performing the inference by the LLM.

The plurality of stock market data may include a company name, a company ticker, a date, at least one financial news comprising raw financial news data and at least one financial news summary, at least one of financial news summary sentiment, at least one of a historical return, and at least one of a financial fundamental.

The LLM may include a predetermined limited token window.

The processor may be further configured to construct the prompt for the LLM based on the prompt technique comprising a chain-of-thought prompting process by: training initially the LLM with an initial set of the plurality of stock market data up to a predetermined timepoint that prevents information leakage of the LLM. The process may also include generating tabular data of the plurality of stock market data based on the at least one financial news summary and the at least one of financial news summary sentiment for input into the LLM. The process may also include performing an in-context learning process for the LLM with the tabular data, and conducting a chain-of-verification process for the LLM to check for hallucination by the LLM.

The processor may be further configured to generate the prediction response with the stock rating prediction by generating a rating score for the stock rating. The rating score may include at least one from among a strong sell score, a moderate sell score, a hold score, a moderate buy score, and a strong buy score.

The processor may be further configured to determine an accuracy of the generated prediction response based on computing a forward return for a company, and compare the forward return of the company with at least one respective forward return of at least one other company operating within a similar sector as represented by sector quintiles.

The processor may be further configured to generate the at least one dataset by filtering out data that is unrelated to a company associated with the specified task by a pre-processing LLM. The processor may be further configured to summarize the plurality of stock market data that is unfiltered by the pre-processing LLM. The summarizing may include compiling a company information, a prediction date, the at least one financial news summary, the at least one of a historical return, and the at least one of a financial fundamental with ground-truth forward return quintiles of a company. The processor may be further configured to provide the summarized plurality of stock market data from the pre-processing LLM as the input into the LLM.

The processor may be further configured to: train further the LLM with a dataset comprising training data and validation data to perform the inference, and fine-tune the LLM based on a predetermined low-rank adaptation technique comprising an injection of at least one predetermined low-rank matrix into a transformer layer of the LLM.

According to yet another embodiment, a method for fine-tuning a large language model to generate a stock rating prediction may be provided. The method may be implemented by at least one processor. The method may include performing, by a large language model (LLM), an inference of at least one dataset generated from a plurality of stock market data based on constructing a prompt with a specified task comprising a prediction task regarding a stock rating. The method may also include generating, by the LLM, a prediction response comprising the stock rating prediction based on the performing the inference. The method may also include computing a cross-entropy loss between the prediction response and a ground-truth stock rating. The method may also include fine-tuning the LLM to minimize the cross-entropy loss based on a predetermined low-rank adaptation technique comprising an injection of at least one predetermined low-rank matrix into a transformer layer of the LLM.

The plurality of stock market data may include a company name, a company ticker, a date, at least one financial news comprising raw financial news data and at least one financial news summary, at least one of financial news summary sentiment, at least one of a historical return, and at least one of a financial fundamental.

The LLM may include a predetermined limited token window value.

The constructing the prompt for the LLM based on a prompt technique may include a chain-of-thought prompting process by: training initially the LLM with an initial set of the plurality of stock market data up to a predetermined timepoint that prevents information leakage of the LLM. The process may also include generating tabular data of the plurality of stock market data based on the at least one financial news summary and the at least one of financial news summary sentiment for input into the LLM. The process may also include performing an in-context learning process for the LLM with the tabular data, and conducting a chain-of-verification process for the LLM to check for hallucination by the LLM.

The method may also include determining an accuracy of the generated prediction response based on computing a forward return for a company, and comparing the forward return of the company with at least one respective forward return of at least one other company operating within a similar sector as represented by sector quintiles.

The method may also include evaluating a performance of the LLM by computing a mean absolute error, and adjusting the LLM by the fine-tuning of the LLM based on the evaluated performance.

The LLM may be trained with a dataset comprising a predetermined ratio of training data to validation data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for training large language models in predicting stock ratings.

FIG. 4 illustrates a flowchart of a process diagram according to an embodiment for training large language models in predicting stock ratings.

FIG. 5 illustrates an example distribution of rating across different experimental methods according to an embodiment.

FIG. 6 illustrates an example of a mean absolute error across time horizons and a composite mean absolute error according to an embodiment.

FIG. 7 illustrates example correlations between the predicted ratings of the different large language model (LLM) outputs and the sentiment scores of the news summaries according to an embodiment.

FIG. 8 illustrates an example of stock ratings and example data ingestion for the LLM and data prediction of the LLM according to an embodiment.

FIG. 9 illustrates an example process of fine-tuning pipeline for the LLM according to an embodiment.

FIG. 10 illustrates an example of constructing a prompt for the LLM according to an embodiment.

FIG. 11 illustrates an example extraction of news summary and news summaries sentiment according to an embodiment.

FIG. 12 illustrates an example evaluation of rating predictions according to an embodiment.

### DETAILED DESCRIPTION

Investment analytics is a cornerstone of the financial services industry. Traditional stock rating methods rely heavily on the expertise of financial analysts and face several challenges such as data overload, inconsistencies in filings, and delayed reactions to market events. Indeed, investment analytics is crucial for the functioning of financial markets, providing essential insights that drive investment decisions, market trends, and economic policies. The tasks of evaluating financial data, preparing reports, making stock recommendations, etc. are important in investment analytics. The expertise associated with these tasks help in valuing assets, assessing investment opportunities, and formulating business decisions. Interpretation of these complex financial information often involve digesting a high volume of complex data, but such interpretation is needed to mitigate risks and identify opportunities for investors.

A crucial task of investment analytics is to publish stock ratings, which evaluate a company's future performance based on forward projections of a company's fundamentals, including earnings, revenue growth, and cash flow, as well as broader market conditions and economic trends. These stock ratings include expert recommendations on how to position companies over the next quarter to a year and thus play a pivotal role in shaping market perceptions.

However, making such predictions of stock ratings in the status quo remains a challenging task due to the complexity and dynamic nature of financial markets. The process the status quo faces several challenges:
Processing and analyzing vast volumes of complex data to formulate ratings.
Inconsistencies in filings can result in varying assessments of similar stocks, causing confusion and uncertainty.
Changes in ratings are sometimes missed, resulting in delayed reactions to market shifts.
Infrequent filings of stock ratings can cause problems as they may not reflect the most current market conditions and can lead to outdated or less relevant assessments.
Potential bias in the stock ratings, e.g., bias for or against certain companies.

Given the challenges of the status quo, the rapid integration of advanced machine learning techniques, particularly Large Language Models (LLMs), presents opportunities to enhance the equity stock rating process. LLMs, with their zero-shot and few-shot learning capabilities, can perform a wide range of tasks efficiently. They offer advanced reasoning capabilities and can efficiently handle large volumes of diverse unstructured data, making them useful in financial analysis. Specifically, LLMs can answer questions, summarize information, write content, and handle multiple tasks simultaneously. They significantly enhance the process of generating stock ratings by analyzing vast amounts of financial reports, assessing the sentiment of news articles, evaluating market commentaries, and more.

Yet, even so, the use of LLMs in investment analytics to make investment predictions still face several challenges. For instance, to make accurate predictions, the LLMs would need to be trained on a wide variety of relevant datasets. However, the data format of these diverse datasets can vastly differ from one dataset to another, thus making it difficult for the LLMs to ingest and be trained on the diverse datasets given the LLMs' context length limitations, difficulties with tabular and numerical data, and the risk of generating inaccurate responses. That is, there are training bottlenecks, computational bottlenecks, and fine-tuning bottlenecks associated with the LLMs in making accurate investment analytic predictions. As such, these challenges prevent the LLMs from efficiently generating accurate responses to queries regarding market or investment matters.

The present application provides a technological improvement by disclosing an instruction-based general purpose LLM for predicting analyst stock ratings and fine-tuning of this LLM for this prediction task. Various data types such as fundamental financial data (tabular/semi-structured), market data (timeseries), and news data (unstructured) from a predetermined time frame are provided to the LLM to utilize in making the predictions. An example of the predetermined time frame may be, but is not limited to, January 2022 to March 2024. The LLM is trained and fine-tuned to avoid information leakage to prevent overly optimistic performance results.

Additionally, the present application enables quick and consistent generation of ratings by leveraging LLMs for various applications, including data procurement, analysis, and prediction. This consistency of ratings output from an LLM helps to avoid the problem of ratings clustering and inconsistencies, where multiple different ratings for the same stock can cause confusion. By delivering uniform and dependable ratings, these predictions from the LLM can help investors make clearer and more confident decisions.

Another advantage of the present application is its ability to provide timely awareness of changes in ratings. By predicting analyst stock ratings with the LLM in the manner as recited herein, the present application can capture changes more swiftly, allowing investors to react promptly to market shifts. This timely awareness is critical for making informed investment decisions and optimizing investment performance. The present application highlights the potential of LLMs to deliver accurate and interpretable predictions for analyst stock ratings, outperforming traditional methods of the status quo.

The present application provides advantages over the status quo through:
Demonstrating the novel application of a LLM in predicting analyst stock ratings and fine-tuning of the LLM to perform this prediction.
Evaluating the performance of a LLM in this predictive task to determine which data sources enhance or impede predictive capabilities over various future time horizons.
Building a reproducible framework to quickly and consistently generate predictive stock ratings as evaluated by forward-returns.
Providing a framework that enables a LLM in the financial forecasting process by addressing both the prediction of stock ratings and subsequent stock price movements.

Indeed, within the status quo, the area of research regarding predicting stock ratings is not explored as compared to other areas of research, e.g., research regarding predicting stock movements. The present application address this shortcoming in the status quo by demonstrating the application of a LLM to predict analyst stock ratings, addressing a significant and under-explored gap in financial research.

By focusing on the LLM in predicting stock ratings and the various data types that influence predictions, the present application provides a novel framework and dimension of predictive power for ratings and company performance, significantly enhancing both the accuracy and interpretability of these predictions. Notably, the innovative methodology as described in the present application below helps to bridge existing gaps and sets a new benchmark in financial forecasting.

For these various reasons, the present application provides a technological improvement of the status quo because it discloses improved techniques to generate a stock rating prediction by a LLM and for fine-tuning a LLM to generate a stock rating prediction. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

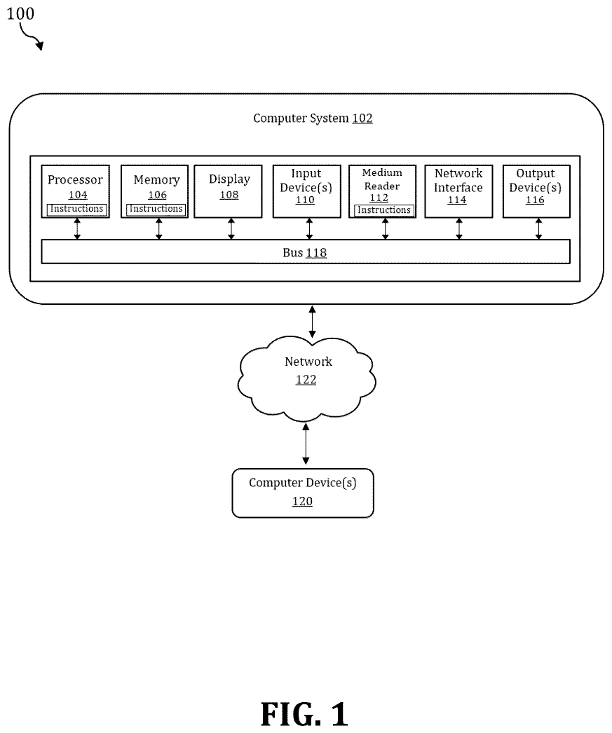

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for fine-tuning large language models (LLMs) in predicting stock ratings.

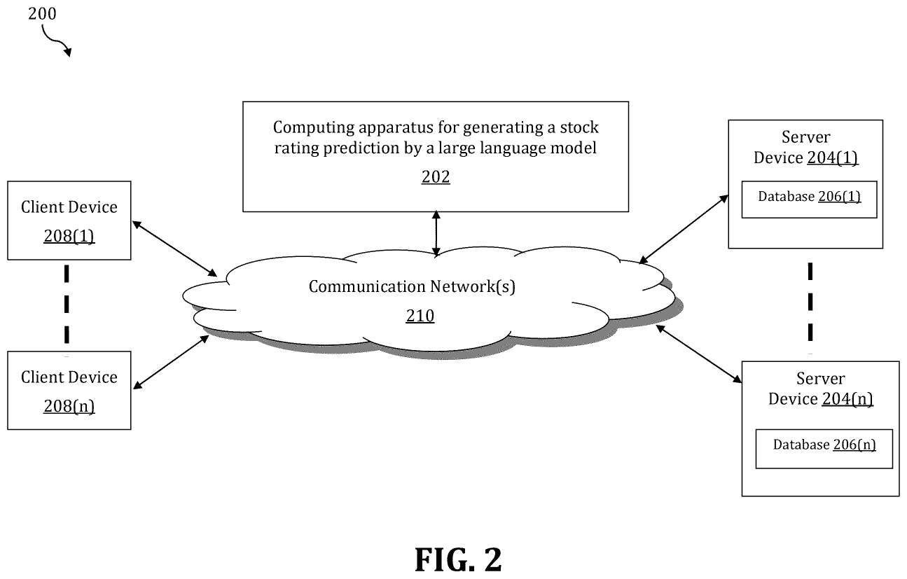

Referring to FIG. 2, a network diagram of a network environment 200 for generating a stock rating prediction by a LLM and for fine-tuning a LLM to generate a stock rating prediction and may be illustrated. In an embodiment, the method may be executable on any networked computer platform, such as, for example, a personal computer (PC).

The methods for generating a stock rating prediction by a LLM and for fine-tuning a LLM to generate a stock rating prediction may be implemented by a computing apparatus 202 that implement a generating a stock rating prediction by a LLM and for fine-tuning a LLM to generate a stock rating prediction. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating a stock rating prediction by a LLM and for fine-tuning a LLM to generate a stock rating prediction.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

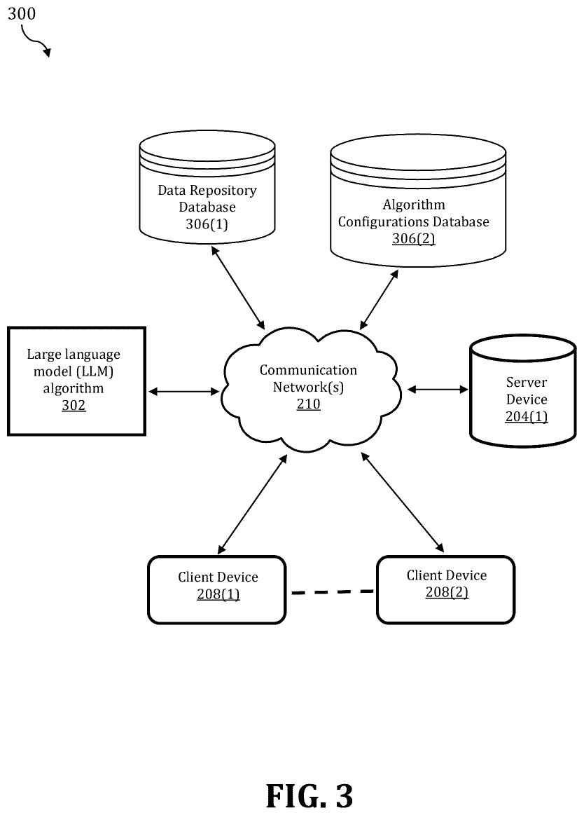

The computing apparatus 202 may be described and illustrated in FIG. 3 as may include a LLM algorithm 302, although it may include other rules, algorithms, policies, modules, databases, or applications, for example. As will be described below, the LLM algorithm 302 may be configured to implement methods of generating a stock rating prediction by a LLM and for fine-tuning a LLM to generate a stock rating prediction.

FIG. 3 illustrates a diagram of a system environment 300 for implementing methods of generating a stock rating prediction by a LLM and for fine-tuning a LLM to generate a stock rating prediction by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The LLM algorithm 302 may be configured to access these databases for implementing the methods of generating a stock rating prediction by a LLM and for fine-tuning a LLM to generate a stock rating prediction.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

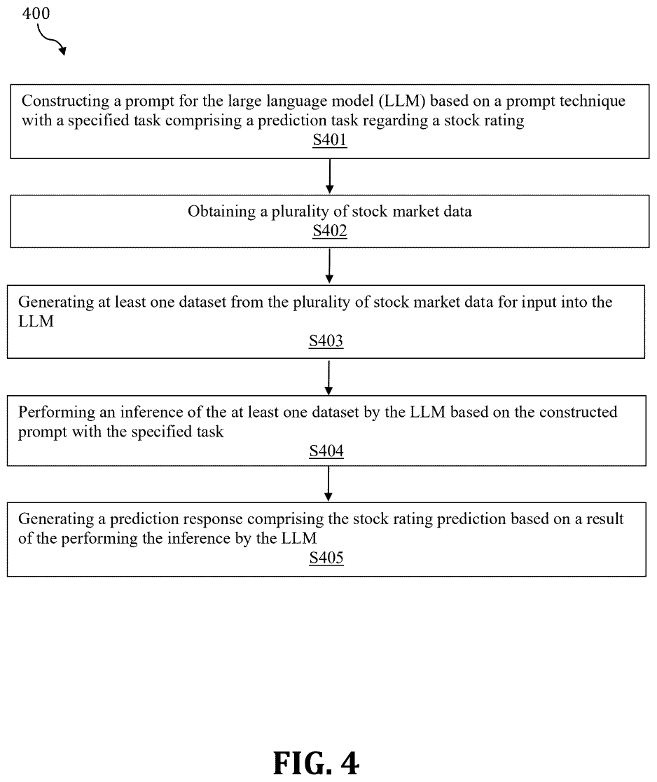

The LLM algorithm 302 may execute a process implementing methods of generating a stock rating prediction by a LLM and for fine-tuning a LLM to generate a stock rating prediction. A process for generating a stock rating prediction by a LLM may be generally indicated at flowchart 400 in FIG. 4.

FIG. 4 illustrates a flowchart of a process diagram 400 of a process for generating a stock rating prediction by a LLM according to an embodiment. The process diagram 400 may be implemented by the system environment 300 of FIG. 3, a network environment 200 of FIG. 2, and the system 100 of FIG. 1.

At step S401 of the flowchart process 400, the computing apparatus 202 may construct a prompt for the LLM based on a prompt technique with a specified task comprising a prediction task regarding a stock rating.

The prompt may be constructed based on the prompt technique that may include, but is not limited to, a chain-of-thought (CoT) prompting process. The CoT prompting process may include training initially the LLM with an initial set of the plurality of stock market data up to a predetermined timepoint that prevents information leakage of the LLM. The up to a predetermined timepoint may be at a timepoint before the ground truth data of a stock is released (e.g., news release of a stock rating). For example, if the ground truth data for a stock, such as its stock rating, is released on January 2022, then to prevent information leakage of the LLM, the LLM should be trained on the plurality of stock market data that is sufficiently before January 2022. So, in the example, the LLM can be trained up to a predetermined timepoint before January 2022. This predetermined timepoint may be selected as desired. Additionally, the LLM may have a predetermined limited token window value, e.g., context window of tens of thousands of token windows, e.g., at least 32K token windows. The LLM may be hosted on a remote platform or cloud-based server.

The CoT prompting process may also include generating tabular data of the plurality of stock market data based on the at least one financial news summary and the at least one of financial news summary sentiment for input into the LLM. The tabular datasets enable efficient ingestion of data by the LLM. Company-specific input data may be provided to the LLM in a structured format, such as a tabular dataset, with textual information first followed by numerical data in tables. The CoT prompting process may also include performing an in-context learning process for the LLM with the tabular data, and conducting a chain-of-verification process for the LLM to check for hallucination by the LLM.

The CoT prompt may include breaking down a problem, e.g., a problem posed in a query, into a multi-step process with a reasoning related to each of the multi-step to think through the various multi-steps to reach a solution. Additionally, the construction of the prompt may involve CoT with few-shot prompt technique encourage the LLM to engage in reasoning before making its final prediction and provide it with an example of what the output should look like.

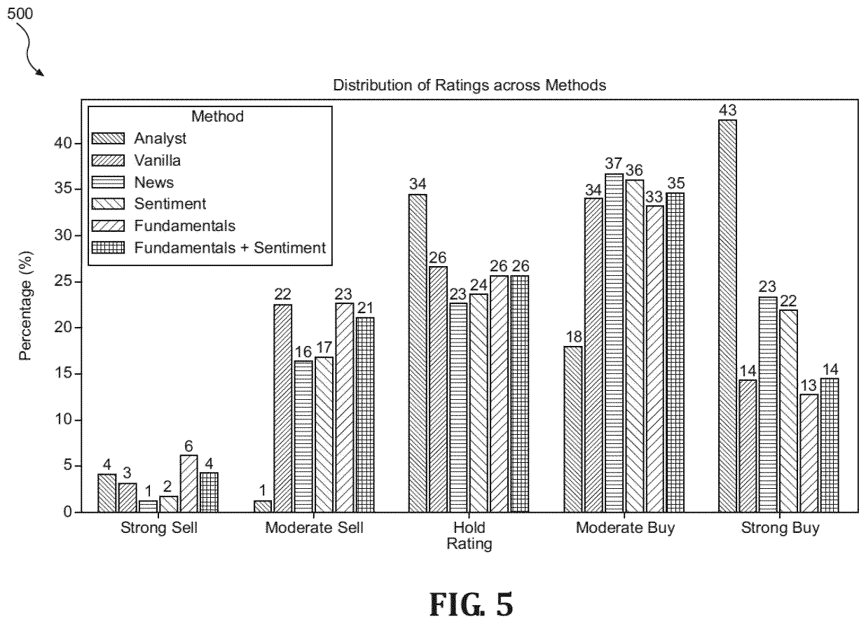

At step S402 of the flowchart process 400, the computing apparatus 202 may obtain a plurality of stock market data. Examples of the plurality of stock market data may include, but are not limited to, company name, a company ticker, a date, at least one financial news comprising raw financial news data and at least one financial news summary, at least one of financial news summary sentiment, at least one of a historical return, and at least one of a financial fundamental. Further details are provided in FIG. 5.

At step S403 of the flowchart process 400, the computing apparatus 202 may generate at least one dataset from the plurality of stock market data for input into the LLM. The generating at least one dataset may include filtering out data that is unrelated to a company associated with the specified task by a pre-processing LLM. The generating at least one dataset may also include summarizing the plurality of stock market data that is unfiltered by the pre-processing LLM. The summarizing may include compiling a company information, a prediction date, the at least one financial news summary, the at least one of a historical return, and the at least one of a financial fundamental with ground-truth forward return quintiles of a company. The generating at least one dataset may also include providing the summarized plurality of stock market data from the pre-processing LLM as the input into the LLM. Further details are provided in FIGS. 5, and 8-11.

When ingesting a high volume of data, one of the challenges in handling such large volumes of news data is how to do so while remaining within token limits. Additionally, there is a risk of the LLM performing the prediction from being overwhelmed by data, thus making it more prone to ignoring other key factors for making predictions. Thus, to address these issues, before initiating the stock rating prediction pipeline, summarized versions of articles for the companies of interest need to be generated. A pre-processing LLM may be utilized to summarize news and instructed to filter out irrelevant articles, e.g., those not relating to the company of interest, and retaining only key events. Next, a different LLM may be leveraged, i.e., the LLM making the predictions, to produce sentiment scores for the summarized news. Such sentiment scores can be: −5 indicates extremely/entirely negative news, 0 indicates mixed or neutral news, and +5 indicates extremely/entirely positive news.

This process enables a distillation of large amounts of information into a compact form that the LLM making the prediction can process effectively to make predictions while retaining the most critical details without being bogged down by the high volume of information. As a result, the LLM making the stock ratings predictions just only receives concise and relevant information it needs from the pre-processing LLM.

For stock market data, such as those including financial fundamentals and technical indicators (e.g., 52-week price range, 90-day volatility), this data may be generated in a tabular format using HTML tags. The data are presented in a tabular format because LLMs are better at understanding tables and numerical data when presented in structured formats, e.g., in these tabular formats, than in a free-from format. By generating the data into a tabular format, it can be ensured that the LLM can properly ingest the input materials to accurately interpret numerical data for integration into the LLM's predictive and decision-making processes.

At step S404 of the flowchart process 400, the computing apparatus 202 may perform an inference of the at least one dataset by the LLM based on the constructed prompt with the specified task. Further details are provided in FIGS. 5-12.

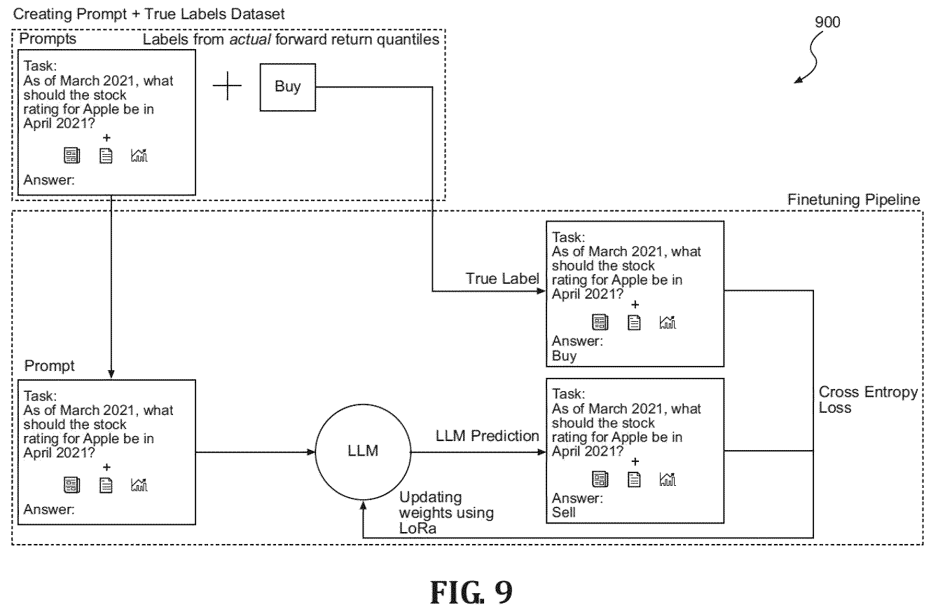

To perform the inference, in-context learning may be utilized by providing the LLM with an example of an input-output pair, which is further described in FIG. 9. Utilizing the in-context learning technique may improve the LLM's ability to generalize across various companies and financial scenarios by giving it a clear sense of what the expected output should look like. The in-context requires the model to engage in reasoning before predicting ratings, thus enforcing accuracy and context comprehension.

At step S405 of the flowchart process 400, the computing apparatus 202 may generate a prediction response comprising the stock rating prediction based on a result of the performing the inference by the LLM. The generating the prediction response may include generating a rating score for the stock rating. The rating score may include at least one from among a strong sell score, a moderate sell score, a hold score, a moderate buy score, and a strong buy score.

The computing apparatus 202 may further include determining an accuracy of the generated prediction response based on computing a forward return for a company, and comparing the forward return of the company with at least one respective forward return of at least one other company operating within a similar sector as represented by sector quintiles. The accuracy determination can be based on computing a Mean Absolute Error (MAE) of the predicted stock ratings against the ground-truth stock ratings, computing a cross-entropy loss between the prediction response and ground-truth stock ratings, and/or perform a chain of verification (CoVe) of the multi-steps to detect if the LLM is making accurate predictions for the correct dates.

The accuracy determination may be based on a problem formulation. Let rating_{c} (t, p) be a rating for a company c released on date t, predicting the company's performance at a future horizon of p months. The rating can take any of the following ordinal values: rating_{c} (t, p)∈{−2, −1, 0, 1, 2}, where −2=Strong Sell, −1=Moderate Sell, 0=Hold, 1=Moderate Buy, and 2=Strong Buy.

The accuracy of a predicted stock rating may be achieved by evaluating how the company's stock performs. This approach is commonly used in utilizing future returns. Thus, to determine the accuracy of a rating denoted by rating_{c} (t, p), the performance of the company c may be evaluated using its forward returns (at period t+p), and compare it to other companies. This may be done by computing a company returns for the entire group (e.g. S&P500 constituents) at a fixed time horizon, and then dividing these into quintiles.

The quintile groups can correspond to rating levels, e.g., companies with returns in the lowest quintile significantly underperformed their peers, making their ground truth rating a Strong Sell.

This process may be achieved as follows. First, the forward company returns as well as market and sector relative returns are calculated, whereby given the price for company c at time t, P_{c} (t), the company return R_{c} (t, p) over the period p is defined as:

$${R}_{c} ( t , p ) = \frac{{P}_{c} ( t + p ) - {P}_{c} ( t )}{{P}_{c} ( t )} .$$

The sector-relative forward return Rc,s (t, p) is defined as:

$${R}_{c , s} ( t , p ) = {R}_{c} ( t , p ) - {R}_{s} ( t , p )$$

where the sector return Rs (t, p) over the same period p is:

$${R}_{s} ( t , p ) = \frac{{P}_{s} ( t + p ) - {P}_{s} ( t )}{{P}_{s} ( t )} .$$

For a rating released on date t with a horizon of p, we compute the quantiles of returns across all companies c at t+p and assign each company the quantile that their returns fall into. If the returns quantile matches the rating, then the rating is considered correct.

Let Q_{c} (t, p) represent the quantile of the company returns R_{c} (t, p), Q_{c,m} (t, p) represent the quantile of the market-relative returns R_{c,m} (t, p), and Q_{c,s} (t, p) represent the quantile of the sector-relative returns R_{c,s} (t, p).

The indicator function can be defined for the correctness of the rating denoted as rating_{c} (t, p) with respect to the absolute performance quantile Q_{c} (t, p) as follows:

$$𝕀 ( {rating}_{c} ( t , p ) = {Q}_{c} ( t , p ) ) = \{ \begin{matrix}1 & if {rating}_{c} ( t , p ) = {Q}_{c} ( t , p ) \\ 0 & otherwise\end{matrix} .$$

Similarly, for sector-relative returns:

$${𝕀}_{sector} ( {rating}_{c} ( t , p ) = {Q}_{c , s} ( t , p ) ) = \{ \begin{matrix}1 & if {rating}_{c} ( t , p ) = {Q}_{c , s} ( t , p ) \\ 0 & otherwise\end{matrix} .$$

Continuing with FIG. 4, the computing apparatus 202 may also further include training further the LLM with a dataset comprising training data and validation data to perform the inference, and fine-tuning the LLM based on a predetermined low-rank adaptation technique comprising an injection of at least one predetermined low-rank matrix into a transformer layer of the LLM. Further details are provided in FIG. 9.

That is, a multi-step task process may be utilized by the LLM based on the CoT prompting to perform the inference and fine-tune the LLM. The first stage of multi-step task process may involve the prompt construction, wherein the task is defined and the LLM is asked to predict the dates that the stock ratings correspond to. This initial step serves purpose of hallucination detection and verification since if the LLM fails to predict the correct dates, then it raises a red flag about the accuracy of the rating prediction itself. Additionally, this step also acts as a CoVe, enabling an evaluation as to whether the LLM can perform a simpler task of date prediction.

The second step of the multi-step process may involve utilizing in-context learning because requiring the LLM to engage in reasoning before predicting ratings can further enforce accuracy and context comprehension. In the third step of the multi-step process, the LLM may be asked to provide an explanation based on the available data, followed by the actual rating. This three-step process both aids in identifying potential model hallucinations and enables us to verify if the prediction is well-supported by the data from the explanation

FIG. 5 illustrates an example distribution 500 of rating across different experimental methods according to an embodiment as described in FIG. 4, such as the at least one user preference dimension. The example distribution 500 is based on various experimental methods involving different in-context data configurations: vanilla, news, sentiment, fundamentals, and fundamentals and sentiment. For each experiment, a LLM is specifically tailored to perform each of the experiments based the experiment's description as described below.

The example distribution 500 plots value counts of stock ratings across all months for all experiments. Each experiment asks the LLM to generate stock ratings at the beginning of each month from January 2022 to June 2024, for each company in the S&P 500. The ratings are made for varying time horizons: 1, 3, 6, 12, and 18 months ahead. For each experiment, there are approximately 5 (horizons)*30 (start dates)*500 (companies) ratings. Multiple horizons were used because the target date for the human analyst's rating was not available for comparison, so multiple data points were assessed in the future time horizons. Moreover, varying time horizons allowed for a measurement of the LLM's efficacy across different periods. The LLM being the LLM making the predictions of the stock ratings.

For the vanilla category experiment, the input context includes a snapshot of the company's historical data: returns, market-relative returns, and sector-relative returns for the past 1-month, 3-month, and 12-month periods. Additionally, the current stock price (as of rating date) is also provided, as well as the 52-week price range (min, max), and the 90-day volatility (standard deviation of daily returns). In total, the LLM may receive 10 values describing historical returns (1 for volatility), plus 3 values relating to the stock price (current and 52-week min-max), for a total of just 13 numbers. These simple data points may greatly improve the LLM's ability to generate accurate ratings. This setting serves as the baseline for the experiments.

Regarding the historical returns data, for a similar time frame as the news summary data, daily stock prices for companies in the S&P 500 were collected to compute technical indicators using the prices. The metrics include current price, the 52-week price range, 90-day volatility, and performance metrics over 1-month, 3-month, and 12-month periods. The performance metrics are divided into returns, market relative returns, and sector relative returns.

For the news category experiment, this experiment enhances the input prompt for the vanilla experiment by including news data. As it is not pragmatic to include entire news articles due to LLM context limits, just summaries of company news and sector news from the previous month are provided to the LLM. In addition to the outputs described above, the LLM is also tasked with assessing the sentiment of the news summaries provided (positive, negative, neutral, or mixed), and to use this in its predictions. The LLM in this experiment shows an improved performance when the LLM receives the news summaries earlier in the context (before the technical indicators).

For the news category experiment, news articles for stocks in the S&P500 were collected. Pre-processing of the news articles may be performed using named entity recognition (NER) with the pre-processing LLM to filter irrelevant content out by utilizing both company names and possible company aliases to enhance this process. That is, aliases may be used to ensure that the raw news text accurately corresponds to the company that such raw news are being attributed to. For example, if a text contains a certain number of mentions of a company's name or its aliases, then it may be concluded with greater confidence that the news is indeed about that company, i.e., the news are attributed to that company. After filtering down to relevant data, the dataset consists of the following: on average per month, there are 39.63 articles, 187.44K characters, and 39.78K tokens, with 74.70 URLs and 34.40 missing articles per ticker. The monthly news for each company and sector were summarized using the LLM to highlight key events and trends. A constructed prompt can designate that the pre-processing LLM act as an expert news summarizer, tasked with condensing articles into concise summaries that highlight key events and important information, while excluding irrelevant content, for input into a LLM that performs the predictions of the stock ratings. Two different user prompts may be constructed, one to create summaries for both individual companies, and the other to summarize news across an entire sector, identifying general themes and trends. Each prompt template provides specific instructions and examples to ensure consistency and accuracy in the news summarization.

For the sentiments category experiment, this experiment is similar to the vanilla experiment except for one key difference: the inclusion of pre-computed news sentiment. Unlike the news experiment, which provides the LLM with descriptive news summaries, this experiment supplies the LLM with two sentiment scores, one for company news sentiment, and one for sector news sentiment, both sentiments from the previous month. The summaries used in the sentiment scoring process are the same as the ones provided to the LLM in the news experiment. The sentiment scores can range from −5 to 5, capturing a spectrum of sentiment from extremely negative to extremely positive.

Regarding the sentiments category experiment, the pre-processing LLM may identify the sentiments of the financial news summaries on the company and sector level. A constructed prompt may assign a role to the pre-processing LLM to act in the role of an expert in news sentiment scoring, particularly for financial markets, using a scale from −5 to 5 to indicate the sentiment's severity. Two user prompts may be constructed, one to score the sentiment of news summaries for individual companies and the other for scoring sentiment at the sector level. Each prompt template provides specific instructions and examples to ensure consistency and accuracy in the sentiment scoring.

For the fundamentals category experiment, this experiment augments the constructed prompt in the vanilla experiment with quarterly financial fundamental data. The LLM is supplied with company financial metrics and detailed descriptions of each metric. Instructions for the LLM are updated with definitions of the fundamental features. The LLM is tasked with analyzing these numbers in its process. The fundamentals are provided to the LLM in an HTML format, as HTML seems to outperform other formats for LLM ingestion. Regarding the fundamentals category experiment, quarterly company fundamentals from 10-Q and 10-K filings from January 2022 to March 2024 were aggregated using a financial application program interface (API) to access the U.S. Securities and Exchange Commission (SEC) API. The past 4 quarterly fillings available for each prediction date were collected. These filings, submitted by companies to the SEC, provide detailed information on their balance sheet, income statements, and cash flow statements.

For the fundamentals+sentiments category experiment, this experiment builds upon the fundamentals experiment by also including the sentiment scores used in the sentiment experiment. The setup is similar, with two scores capturing company sentiment and sector sentiment from news from the previous month. The LLM is prompted to use both the fundamental data and sentiment scores to make its predictions.

For the human analyst category, this represents the real-world ratings from human financial analysts across various Wall Street firms, which was then used to measure against the LLM's predictions as derived from the various experiments. Data can be obtained from the analyst's stock ratings for each company in the S&P 500. Out of a total of 45,000 ratings from 126 firms, the majority of ratings (75.90%) were maintained, followed by reiterate (7.25%), downgrade (6.27%), upgrade (5.68%), and initiate (4.89%). The top five investment and banking firms accounted for 31.61% of all ratings. This dataset comprises the firms issuing the rating, the date of the rating, and the rating itself. However, data for the target date or the target price was not provided. Note that for a particular date and company, there may be multiple ratings issued by different firms.

For these experiments, the LLM is provided with the constructed prompt with a query and task description to operate a financial analyst. For each query, the name of the company, the date on which the ratings will be released, and the five forward-looking time horizons for which it needs to generate ratings are provided to the LLM. Additionally, with the CoT prompting framework, the LLM is also asked to output the corresponding price targets, along with a short explanation. The LLM's response to verify that it is computing the dates which each time horizon corresponds to correctly. The results of the experiments are shown in FIG. 5 and compared with that of a human analyst's results (denoted as “Analyst” on the plot of the example distribution 500).

The example distributions 500 compare the predicted outputs from the LLM for the various experiments with that of a human analyst and as compared amongst the various experiments themselves. The following describes the plot of the example distributions 500.

Between a human analyst and the LLM in the vanilla experiment, the plot shows that analysts are heavily biased towards buy ratings, and only gave sell ratings less than 5% of the time. As shown in Table 1, the vanilla experiment has a lower MAE of 1.447 compared to the analyst's predictions, which has a Return MAE of 1.570. This indicates that the LLMs predictions, even with only basic financial data, are more accurate than those made by analysts. However, the standard deviation of the vanilla experiment is 0.745, higher than the analyst's 0.637, suggesting that while the predictions are more consistent, they are less accurate overall. Sector Return MAE and standard deviation follow the same trend.

TABLE 1
Evaluation Averaged Across 3, 6, and
12 Month Periods for Experiments.

| | Return MAE ± | Sector relative return |
|---|---|---|
| Experiment | Std deviation | MAE ± Std deviation |
| Human Analyst | 1.570 ± 0.637 | 1.591 ± 0.648 |
| Vanilla | 1.447 ± 0.745 | 1.459 ± 0.749 |
| News | 1.491 ± 0.738 | 1.513 ± 0.744 |
| Sentiments | 1.496 ± 0.752 | 1.512 ± 0.755 |
| Fundamentals | 1.421 ± 0.732 | 1.439 ± 0.739 |
| Fundamentals + Sentiments | 1.417 ± 0.747 | 1.441 ± 0.752 |

Between the news experiment and the sentiment experiment as shown in the plot in FIG. 5, Table 1 states that the news experiment, for which the previous month's news summaries for the company and the sector was provided to the LLM, results in a Return MAE of 1.491 and a standard deviation of 0.738. The sentiment experiment, for which the sentiment scores of the news summaries instead of news summaries themselves (scored on a scale of −5 to 5), results in a Return MAE of 1.496 and a standard deviation of 0.752. Interestingly, neither experiment outperformed the vanilla experiment.

Additionally, no noticeable improved performance was observed when including summaries compared to only including their sentiment. The trends for Sector Relative Return MAE are consistent with the Return MAE metrics.

Between the fundamentals experiment and the fundamentals+sentiment experiment as shown in the plot in FIG. 5, Table 1 states that the fundamentals+sentiment experiment has the best performance in terms of Return MAE, with a value of 1.417, indicating the most accurate predictions. The fundamentals experiment has a Return MAE of 1.421 and a lower standard deviation of 0.732, indicating more consistent predictions.

Overall, the results as shown in FIG. 5 and tabulated in Table 1, show that for all the LLM experiments (vanilla, news, sentiment, fundamentals, and fundamentals+sentiment), the errors increase as predictions are further into the future, indicating that the LLMs are better at short-term predictions and struggle with longer-term forecasts. News-based experiments (especially news) perform best in the short term due to the immediate impact of news. Notably, the sentiment experiment generally performs similarly to the news, indicating that incorporating sentiment analysis does not significantly improve performance compared to providing news. Fundamentals experiment and fundamentals+sentiment experiment also perform similarly, excelling in the medium term.

As such, the results from the various experiments can be summarized as follows:
The vanilla experiment, which uses basic financial metrics, demonstrates stronger performance than traditional analyst evaluations when assessed by forward returns.
The fundamentals experiment outperformed all experiments, highlighting the significant impact of financial fundamentals on prediction accuracy. Additionally, combining sentiment scores with this data, without the full news summaries, further improved prediction accuracy.
Integrating news summaries and sentiment analysis provides some short-term predictive benefits, but does not significantly improve long-term prediction accuracy when compared to the vanilla experiment.
The performance difference between adding news as text versus news sentiment to the LLM is very small when other data is not included (i.e., fundamentals data), indicating that both approaches offer similar benefits.
The LLM may perform better in short-term predictions, which encourages further exploration of their capabilities for shorter period company predictions.
News experiment are more beneficial for short-term predictions.

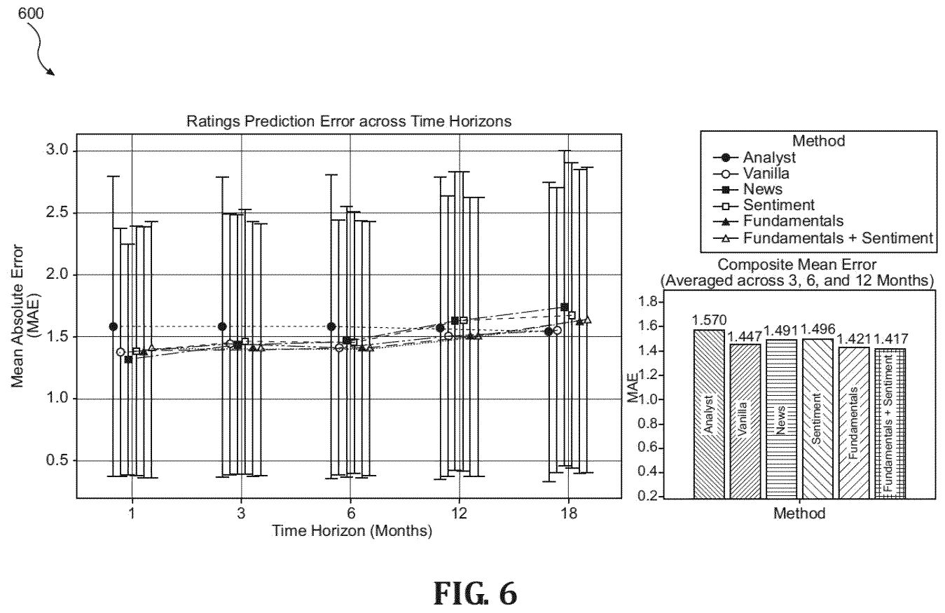

FIG. 6 illustrates an example 600 of mean absolute error across time horizons and a composite mean absolute error according to an embodiment as described in FIG. 4, steps S403-S405. The example 600 shows a Mean Absolute Error (MAE) across different time horizons with a mean and a standard deviation for each experiment and time horizon. The MAE may be used to compute a ratings prediction error. Additionally, the example 600 also shows a Composite Mean Error, which is calculated via a MAE averaged across 3, 6, and 12-month time horizons.

The example 600 shows that errors for the analyst's predictions decrease as the look-ahead periods increase, with slightly better performance in the 18-month period, while errors for vanilla experiment increase (see also Table 1).

The example 600 plot also shows that the news experiment performs best in the 1-month period, outperforming all other experiments in both Return and Sector MAE. This suggests that news summaries can provide better short-term predictions, likely because these summaries are recent from the previous month, therefore offering a clearer picture of recent company's performance. The sentiment experiment performs similarly to the news experiment, indicating that incorporating sentiment does not significantly improve performance when compared to news summaries.

The example 600 plot also shows that both the fundamentals experiment and fundamentals+sentiment experiment consistently perform best across most months, particularly excelling in the 3, 6, and 12-month periods. This stable performance across horizons reinforces the benefits of incorporating fundamental financial data. The fundamentals+sentiment experiment outperforms in the 3 and 6-month periods, demonstrating that combining fundamentals and sentiment scores is effective in the short term but may lead to conflicting signals over longer periods.

As shown in the example 600 plot, the predicted stock ratings were evaluated based on forward returns over 1, 3, 6, 12, and 18-month periods, including evaluations for market-relative and sector relative returns. A rating is considered correct if the quantile for the true forward return aligns with the rating's rank. In an example, let us take a rating for a particular company with a 6-month horizon, regardless of whether the rating is from an analyst or LLM. Suppose the stock was rated as a Strong Buy for the 6-month horizon, and the company's 6-month forward return falls in the bottom quantile (based on 6-month forward returns from the same date for all companies). This constitutes a significantly incorrect rating, as the company was amongst the worst performers in the market, but was rated as a Strong Buy. The ground truth rating in this case would have been a Strong Sell. Conversely, if another experiment generated a rating of Hold for the same <company, date, horizon> combination, then the rating would still be incorrect, but less severely so.

The Mean Absolute Error (MAE) may be computed using two types of returns: regular market-relative forward returns (these automatically become market-relative due to the quantile ranking evaluation), and sector-relative forward returns (where the subsector's forward return is subtracted from the asset return). MAE is appropriate for ordinal classification because it considers the magnitude of the error and accounts for how far a rating is from its true value. Ratings further away from the ground truth are penalized more. Accuracy, a popular metric for classification tasks, treats all errors equally, regardless of their severity. Since there is a balanced distribution of classes (due to quantization), MAE does not need to be adapted, however metrics such as macro-averaged MAE can be utilized in those scenarios.

A composite error may be computed to compare methods more easily. The marker-relative return may be averaged based MAE over the three most common time horizons in this domain: 3, 6, and 12-month periods, as the 1-month rating is usually too soon to be useful. The 18-month predictions are excluded from this score because ratings are typically intended for up to one year, and analysts usually update their ratings for longer-term horizons. Table 1 presents these values, along with a monthly breakdown of performance of all methods across 1, 3, 6, 12, and 18-month periods. These results are shown in FIG. 6.

The example 600 plot shows the experimental results with findings from the month-wise breakdown of the market-relative MAE and sector-relative MAE across all experiments. The plot visualizes how the various experiments stack up to each other, including a snapshot comparison using the composite error (also listed in Table 1). Note that the figures are based on the market-relative MAE.

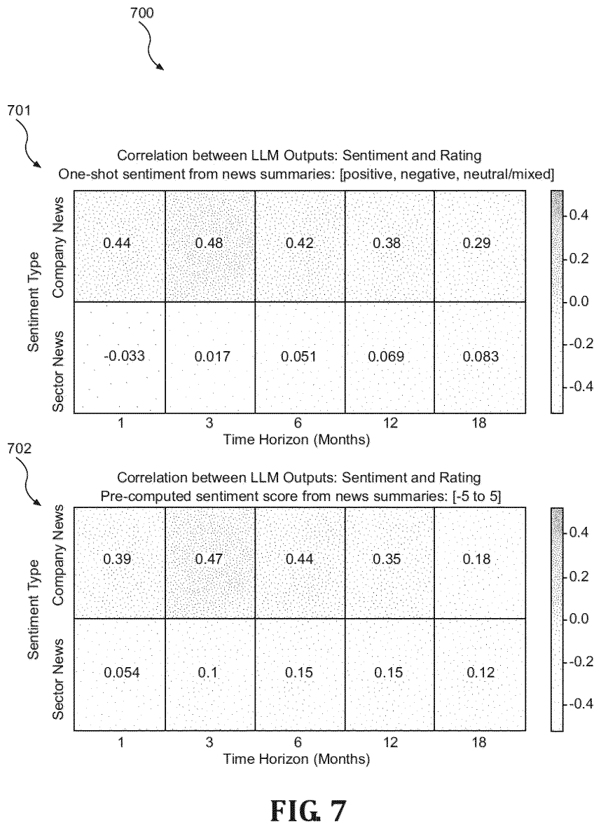

FIG. 7 illustrates example correlations 700 between different large language model (LLM) outputs according to an embodiment as described in FIG. 4 at step S405. The example correlations 700 shows a correlation between the LLM's sentiment prediction and ratings across time horizons for two methods: news (top) 701 and sentiment (bottom) 702.

That is, to better understand the impact of news on the results, a Spearman correlation is computed and heatmaps were generated for the news experiment and sentiment experiment. The Spearman correlation helps to measure strength and direction of association between two ranked variables, e.g., the news experiment and the sentiment experiment.

In the news experiment as shown in the heatmap at 701, the LLM was asked to provide a rating for the company news summary and the sector summary before predicting the stock ratings. For the sentiment experiment as shown in the heatmap at 702, each sector and news summary was scored for its sentiment and then these sentiment scores were provided to the LLM during inference instead of the news summaries. In both cases, it was observe that news summaries are correlated across months, especially with the periods closer to the rating. Additionally, the heatmaps as shown in FIG. 7 reveal that LLM ratings are correlated with the predictions made for the previous period. Moreover, FIG. 7 show how utilizing news-derived data biases the model to make more positive ratings.

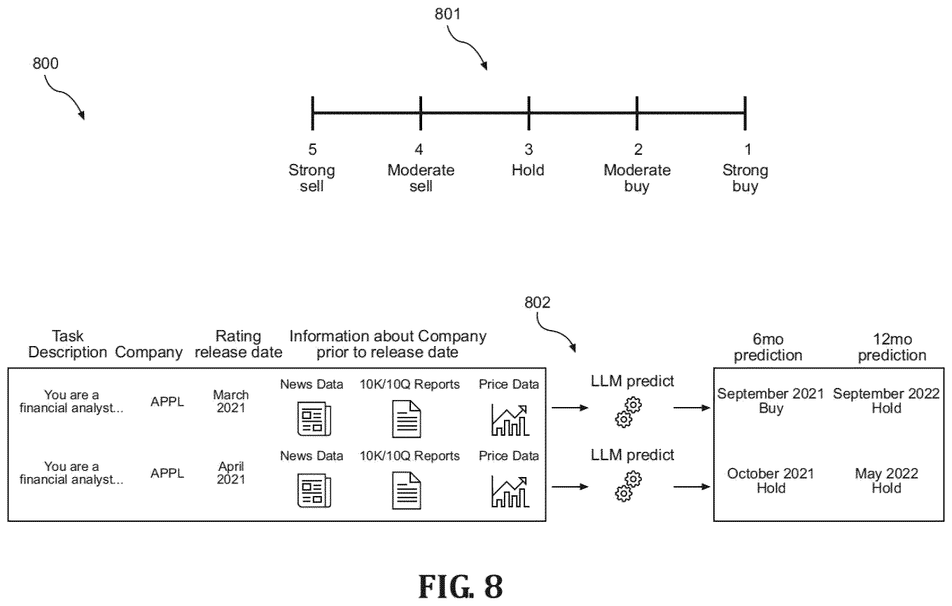

FIG. 8 illustrates an example 800 of stock ratings 801 and example data ingestion for the LLM 802 according to an embodiment as described in FIG. 4 at steps S401-S403.

The stock ratings 801 falls into five categories:
1. Strong Buy/Buy: Indicates that the stock is expected to significantly outperform the market or its sector.
2. Moderate Buy: Suggests that the stock is expected to perform better than the market average or its sector. Also referred to as Outperform or Overweight.
3. Hold: Indicates that the stock is expected to perform in line with the market or its sector.
4. Moderate Sell: Suggests that the stock is expected to perform worse than the market average or its sector. Also referred to as Underperform or Underweight.
5. Strong Sell/Sell: Indicates that the stock is expected to underperform its benchmark significantly.

The stock ratings 801 generally fall within these five categories, although different financial institutions may utilize custom rating scales which can vary between organization. Such ratings are generally published upon a release of a company's quarterly filings, earnings calls, or significant events, updating their guidance for the next quarter, and for rest of the year.

These rating scales are useful because they provide investors with tailored insights and help them make informed decisions based on different analytical perspectives. Past and current qualitative and quantitative information about a company's performance may be used to recommend stock ratings that are then used by investors to make decisions regarding an asset. Common data information used may include:
Fundamental and technical analysis: assessing intrinsic value and trading trends using metrics like earnings-per-share, shares outstanding, return on assets, price, volume, and more.
Company and sector news: considering management changes, product launches, mergers, and regulatory developments.
Market and sector performance: evaluating overall market trends, sector performance, and price movements.

Continuing with FIG. 8, the example data ingestion for the LLM 802 may include a prompt to the LLM that is it act as a financial analyst that analyzes data of a company with a stock ticker of AAPL. That is, the constructed prompt can instruct the LLM to adopt the persona of a financial analyst. By defining this role via the constructed prompt, the LLM can be provided with a clear framework for its function. Additionally, the financial terms utilized may be contextualized by defining the scale of stock ratings and their definitions and incorporating synonyms to account for variations in terminology, as well as providing detailed descriptions of financial fundamentals as input into the LLM.

This enables the LLM to be leveraged to forecast stock ratings for companies (e.g., the company with the stock ticker of AAPL) over specific future periods, such as 6 or 12 months, by providing data commonly analyzed by financial analysts. The data may include: historical returns, company fundamentals, and financial news summaries and sentiment.

For each company (e.g., the company with the stock ticker of AAPL), the relevant data may be aggregated from the previous month, quarter, or year, depending on the release date. This aggregated data may then be fed into the LLM, which generates stock rating predictions for desired time periods such as 3, 6, 12, and 18-month periods. Such stock rating predictions may be buy for September 2021 and holds for October 2021, May 2022, and September 2022.

FIG. 9 illustrates an example process 900 of fine-tuning pipeline for the LLM 900 according to an embodiment as described in FIG. 4 that further correlates to steps S404-S405.

The method of fine-tuning of the LLM to generate a stock rating prediction, as further described regarding the example process 900, may include performing, by the LLM, an inference of at least one tabular dataset generated from a plurality of stock market data based on constructing a prompt with a specified task comprising a prediction task regarding a stock rating. The fine-tuning of the LLM may also include generating, by the LLM, a prediction response comprising the stock rating prediction based on the performing the inference. The fine-tuning of the LLM may include computing a cross-entropy loss between the prediction response and a ground-truth stock rating. The fine-tuning the LLM to minimize the cross-entropy loss based on a predetermined low-rank adaptation technique comprising an injection of at least one predetermined low-rank matrix into a transformer layer of the LLM.

The method of the fine-tuning, as further described regarding the example process 900, may further include evaluating a performance of the LLM by computing a mean absolute error, and adjusting the LLM by the fine-tuning of the LLM based on the evaluated performance. The LLM is trained with a dataset comprising 80% training data and 20% validation data.

The example process 900 involves creating/constructing a prompt and true label dataset, wherein the true labels are derived from labels from actual/ground-truth forward return quintiles of a company. The created/constructed prompt includes the following data: company information, stock market data, historical returns, financial fundamentals, and news sentiment/summaries. Examples of the company information may include, but is not limited to, name, ticker symbol, sector, and industry. Examples of the stock market data may include, but is not limited to, current stock price, 52-week price range, and 90-day volatility. Examples of the historical returns may include, but is not limited to, stock returns over 1-month, 3-month, and 12-month periods, along with market-relative and sector-relative returns. Examples of the financial fundamentals may include, but is not limited to, metrics such as earning per share, net income, debt-to-equity ratio, and return on assets. Examples of the news sentiment/summaries may include, but is not limited to, sentiment scores (e.g., on a scale from −5 to +5) from news articles about the company and sector/brief summaries of impactful news events.

The fine-tuning pipeline in the example process 900 also includes a cross entropy loss computation between the actual/ground-truth label and LLM predictions. Notably, minimizing the cross entropy loss and updating the weights of the LLM using a low-rank adaptation (LoRA) optimization technique.

To efficiently fine-tune the LLMs, LoRA enables a modification of only a small portion of the LLM's parameters, making the fine-tuning process faster and less resource intensive. LoRA may be used to inject trainable, low-rank matrices into the transformer layers of the LLM. Thus, enabling an adjustment of a small percentage of the total parameters of the model. Notably, the parameters associated with the transformer layers of the LLM. This approach ensures that the LLM sufficiently adapts to its stock rating prediction task without needing to retrain the entire LLM, drastically reducing the required time and computational resources.

The cross entropy loss as part of the fine-tuning process is effective for predicting discrete labels (e.g., Strong Buy, Hold) and helps to minimize the difference between the predicted probabilities and the actual stock ratings.

The LLM used for the fine-tuning process may be an open-source LLM capable of performing the task of making predictions. The LLM should be state-of-the-art model that has been optimized for both general and task-specific scenarios with smaller size that allows for faster training times while still maintaining high accuracy. For instance, the LLM may have at least 32K token windows.

The fine-tuning process with the LoRA optimization for the LLM may include dataset preparation, training, monitoring and validation, and regularization. The fine-tuning process may be performed using a graphic processing unit (GPU) tailored to perform machine learning computations. For instance, this GPU may have 24 GB of video RAM and sufficient computational power enabling it to be suited for handling the LLM size and batch sizes required for efficient training.

The dataset preparation may include converting input-output pairs into a format compatible with each LLM, ensuring consistent tokenization for both numerical and textual data. The converting of the input-output pairs may include formatting each prompt that consists of structured data (company info, stock market data, returns, financial fundamentals, sentiment) into a format compatible with each LLM and the corresponding rating predictions. The target outputs generated from the LLM may be based on quantile analysis of forward returns for different time periods (1-month, 3-month, 6-month, 12-month, 18-month).

The training may include a LoRA optimization as applied to a fine-tuned LLM for stock rating prediction. This enables an adjustment to only a small number of parameters, resulting in more efficient training while avoiding overfitting.

The monitoring and validation may include splitting the dataset into training and validation sets (80% training, 20% validation) to track performance. During training, monitored classification accuracy and convergence.

The regularization may include utilizing regularization techniques such as such as early stopping and weight decay as applied to the LLM to ensure that the LLM may generalizes well with unseen data and different company profiles.

After the fine-tuning of the LLM, the LLM's performance may be evaluated using a Mean Absolute Error (MAE). The MAE may enable a clear measure/quantification of how much the predicted stock ratings can deviate from the true ratings and thus, a low MAE is desired. This can then be used to help fine-tune the LLM through updating the LLM's weight using the LoRA optimization to obtain a low MAE. Additionally, classification accuracy can also be used during validation to ensure that the LLM is correctly predicting the stock rating labels.

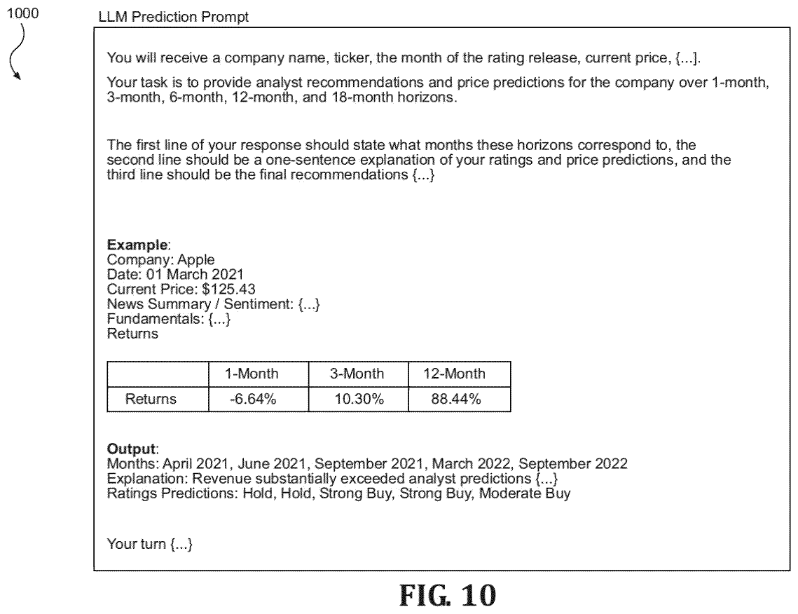

FIG. 10 illustrates an example of constructing a prompt 1000 for the LLM according to an embodiment as described in FIG. 4 at steps S401-S403. The constructed prompt is a prediction prompt for the LLM to perform a prediction stock rating task. FIG. 10 may be an example of an in-depth perspective of the data in FIG. 8 regarding the task description, company, rating release date, and information about the company prior to its release date. This data may be organized in a constructed prompt in a manner as shown in the example 1000 for a company of interest to enable an efficient utilization of the context. This can be achieved by summarizing of the monthly news and score sentiment (−5 to +5) for company and sector news articles through an independent news pipeline for the LLM.

The example 1000 shows that to address information leakage, a LLM with minimal leakage can be utilized. The LLM may have a predetermined context window, e.g., but not limited to, 32K token context window. Information leakage may occur when a model, such as an LLM, is asked to make a prediction on data that is already a part of its training dataset. For instance, if experiments are to be conducted to evaluate how an LLM performs a task, such as predicting stock ratings for 2023, and the LLM has been trained on stock data from 2023, then information leakage is present because the LLM would already be aware of the ground truth data since the ground truth data is already part of its training stock data. Thus, to prevent information leakage, a LLM should be trained using with training data that ends at a predetermined time before a time associated with a predetermined task. So, in the example above, the LLM may be trained with a training dataset that ends well before 2023. In example experiments in the present application, the task of predicting stock ratings may be conducted for a timeframe such as, but not limited to, January 2022 to June 2024. In these experiments, the LLM may be an LLM with, e.g., a 32K token window and trained with a training dataset comprising of data up to, e.g., September 2021. These values and timeframes are recited as examples, and the present application is not to be limited these values and timeframes. Additionally, a chain of verification (CoVe) process, as was previously described above, may be performed to detect hallucination and to mitigate hallucination. This ensures that the predictions of the stock ratings at the various future time horizons are correct.

Tabular data is provided in the example 1000 to the LLM to utilize in making the predictions. In this experiment, fundamentals data and performance metrics are provided to the LLM in an HTML format since it easier for the LLM to ingest data in a HTML format. Additionally, the output shows in-context learning through the various explanations and reasonings as part of the output.

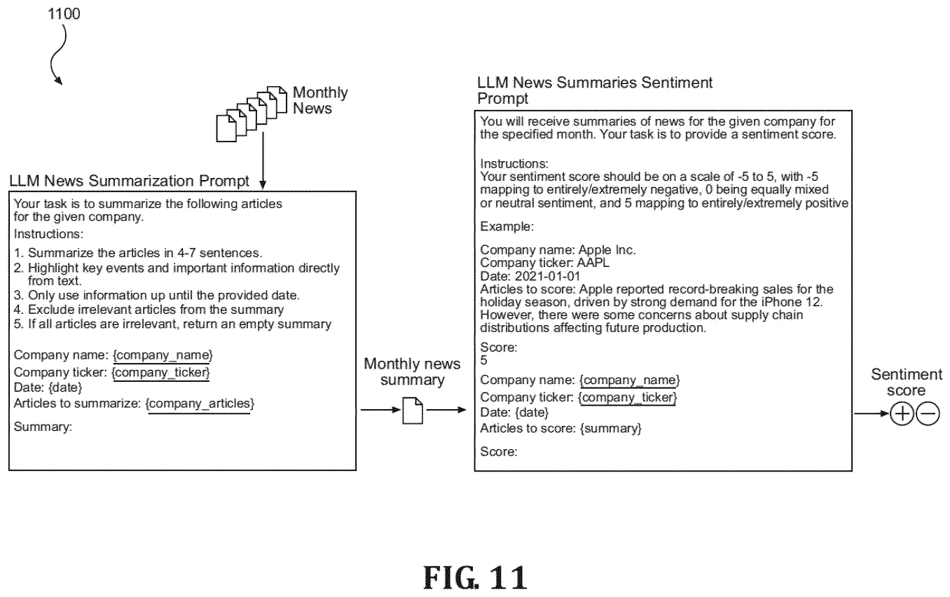

FIG. 11 illustrates an example extraction 1100 of news summary and news summaries sentiment according to an embodiment as described in FIG. 4 at steps S401-S403. The example extraction 1100 shows relevant company data information with an entity relevance check related to the data ingestion. The entity relevance check can be performed using named entity recognition, which was previously described above. This entity relevance check can be repeated as part of the CoT process.

The news data can be summarized by e.g., the pre-processing LLM, wherein just the summaries rather than full news articles can be utilized. The news summary can be aggregated into a monthly news summary and utilized to generate a sentiment score. This summarization and sentiment score generation helps to prevent context overflow for companies with a high volume of data. Additionally, this is also helpful in cases where there are missing data for a company, e.g., sector news fallback.

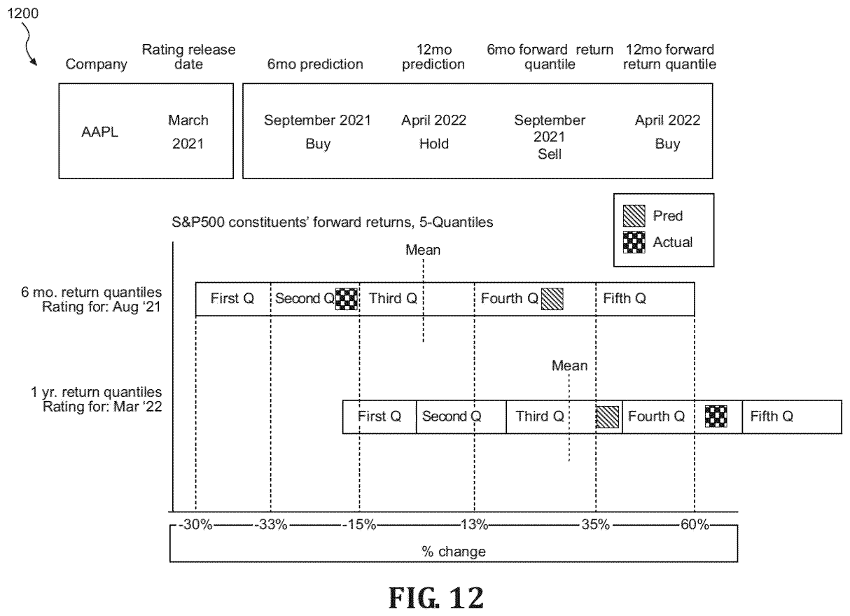

FIG. 12 illustrates an example evaluation 1200 of rating predictions according to an embodiment as described in FIG. 4 at step S405. The example evaluation 1200 shows a prediction result of the stock rating based on the data and prompts shown in FIGS. 10 and 11 for APPLE®. The rating prediction is generated with ordinal regression for ordinal classification by the LLM making the predictions of the stock ratings.

Forward returns for the prediction period were computed and a market-relative assessment was performed. Quantiles from forward returns were computed with match rating category (prediction) to the performance quantile. For instance, if the LLM predicted a “Strong Buy” and the forward returns were in the top 20%, the prediction is considered accurate.

The MAE value was used to evaluate the predictions which is more appropriate for ordinal classification tasks. This means that a prediction of Buy when the actual value was a Hold will be penalized less than in the actual value was Strong sell.

The present application provides advantages over the status quo and technological improvement over the status quo by demonstrating that a LLM along with the fine-tuning process of the LLM can have specific applications in the financial sector through generating accurate stock rating predictions. By preparing the LLM and fine-tuning it with various types of information, including basic financial metrics, technical indicators, financial news summaries financial news sentiment, and financial fundamentals, an evaluation of the predictive performance of LLMs in generating stock rating predictions can be ascertained. Additionally, this also enables a better comprehension of the reasoning utilized by the LLM in performing this predictive task and also in understand which data sources enhance or hinder the predictive capabilities of the LLM in performing this predictive task. Indeed, the various experiments as described in the present application highlight the significant potential of LLMs to provide accurate and interpretable predictions for stock ratings, surpassing traditional methods. Furthermore, while LLMs have been used in predictive tasks in the status quo, this differs from the manner, data, and fine-tuning of the LLMs as described in the present application with regards to predicting stock ratings.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a stock rating prediction by a large language model, the method being implemented by at least one processor, the method comprising:
constructing a prompt for the large language model (LLM) based on a prompt technique with a specified task comprising a prediction task regarding a stock rating;
obtaining a plurality of stock market data;
generating at least one dataset from the plurality of stock market data for input into the LLM;
performing an inference of the at least one dataset by the LLM based on the constructed prompt with the specified task; and
generating a prediction response comprising the stock rating prediction based on a result of the performing the inference by the LLM.

2. The method of claim 1, wherein the plurality of stock market data comprises a company name, a company ticker, a date, at least one financial news comprising raw financial news data and at least one financial news summary, at least one of financial news summary sentiment, at least one of a historical return, and at least one of a financial fundamental.

3. The method of claim 2, wherein the LLM comprises a predetermined limited token window value and wherein the constructing the prompt for the LLM based on the prompt technique comprises a chain-of-thought prompting process by:
training initially the LLM with an initial set of the plurality of stock market data up to a predetermined timepoint that prevents information leakage of the LLM;
generating tabular data of the plurality of stock market data based on the at least one financial news summary and the at least one of financial news summary sentiment for input into the LLM;
performing an in-context learning process for the LLM with the tabular data; and
conducting a chain-of-verification process for the LLM to check for hallucination by the LLM.

4. The method of claim 1, wherein the generating the prediction response comprises generating a rating score for the stock rating; and
wherein the rating score comprises at least one from among a strong sell score, a moderate sell score, a hold score, a moderate buy score, and a strong buy score.

5. The method of claim 1, further comprising:
determining an accuracy of the generated prediction response based on computing a forward return for a company; and
comparing the forward return of the company with at least one respective forward return of at least one other company operating within a similar sector as represented by sector quintiles.

6. The method of claim 2, wherein the generating the at least one dataset comprises:
filtering out data that is unrelated to a company associated with the specified task by a pre-processing LLM;
summarizing the plurality of stock market data that is unfiltered by the pre-processing LLM, wherein the summarizing comprises compiling a company information, a prediction date, the at least one financial news summary, the at least one of a historical return, and the at least one of a financial fundamental with ground-truth forward return quintiles of a company; and
providing the summarized plurality of stock market data from the pre-processing LLM as the input into the LLM.

7. The method of claim 1, further comprising:
training further the LLM with a dataset comprising training data and validation data to perform the inference; and
fine-tuning the LLM based on a predetermined low-rank adaptation technique comprising an injection of at least one predetermined low-rank matrix into a transformer layer of the LLM.

8. A computing apparatus for generating a stock rating prediction by a large language model, comprising:
a processor;
a memory;
a display; and
a communication interface coupled to each of the processor, the memory, and the display, wherein the processor is configured to:
construct a prompt for the large language model (LLM) based on a prompt technique with a specified task comprising a prediction task regarding a stock rating;
obtain a plurality of stock market data;
generate at least one dataset from the plurality of stock market data for input into the LLM;
perform an inference of the at least one dataset by the LLM based on the constructed prompt with the specified task; and
generate a prediction response comprising the stock rating prediction based on a result of the performing the inference by the LLM.

9. The computing apparatus of claim 8, wherein the plurality of stock market data comprises a company name, a company ticker, a date, at least one financial news comprising raw financial news data and at least one financial news summary, at least one of financial news summary sentiment, at least one of a historical return, and at least one of a financial fundamental.

10. The computing apparatus of claim 9, wherein the LLM comprises a predetermined limited token window value and wherein the processor is further configured to construct the prompt for the LLM based on the prompt technique comprising a chain-of-thought prompting process by:
training initially the LLM with an initial set of the plurality of stock market data up to a predetermined timepoint that prevents information leakage of the LLM;
generating tabular data of the plurality of stock market data based on the at least one financial news summary and the at least one of financial news summary sentiment for input into the LLM;
performing an in-context learning process for the LLM with the tabular data; and
conducting a chain-of-verification process for the LLM to check for hallucination by the LLM.

11. The computing apparatus of claim 8, wherein the processor is further configured to generate the prediction response with the stock rating prediction by generating a rating score for the stock rating; and
wherein the rating score comprises at least one from among a strong sell score, a moderate sell score, a hold score, a moderate buy score, and a strong buy score.

12. The computing apparatus of claim 8, wherein the processor is further configured to:
determine an accuracy of the generated prediction response based on computing a forward return for a company; and
compare the forward return of the company with at least one respective forward return of at least one other company operating within a similar sector as represented by sector quintiles.

13. The computing apparatus of claim 9, wherein the processor is further configured to generate the at least one dataset by:
filtering out data that is unrelated to a company associated with the specified task by a pre-processing LLM;
summarizing the plurality of stock market data that is unfiltered by the pre-processing LLM, wherein the summarizing comprises compiling a company information, a prediction date, the at least one financial news summary, the at least one of a historical return, and the at least one of a financial fundamental with ground-truth forward return quintiles of a company; and
providing the summarized plurality of stock market data from the pre-processing LLM as the input into the LLM.

14. The computing apparatus of claim 8, wherein the processor is further configured to:
train further the LLM with a dataset comprising training data and validation data to perform the inference; and
fine-tune the LLM based on a predetermined low-rank adaptation technique comprising an injection of at least one predetermined low-rank matrix into a transformer layer of the LLM.

15. A method for fine-tuning a large language model to generate a stock rating prediction, the method being implemented by at least one processor, the method comprising:
performing, by a large language model (LLM), an inference of at least one dataset generated from a plurality of stock market data based on constructing a prompt with a specified task comprising a prediction task regarding a stock rating;
generating, by the LLM, a prediction response comprising the stock rating prediction based on the performing the inference;
computing a cross-entropy loss between the prediction response and a ground-truth stock rating; and
fine-tuning the LLM to minimize the cross-entropy loss based on a predetermined low-rank adaptation technique comprising an injection of at least one predetermined low-rank matrix into a transformer layer of the LLM.

16. The method of claim 15, wherein the plurality of stock market data comprises a company name, a company ticker, a date, at least one financial news comprising raw financial news data and at least one financial news summary, at least one of financial news summary sentiment, at least one of a historical return, and at least one of a financial fundamental.

17. The method of claim 16, wherein the LLM comprises a predetermined limited token window value and wherein the constructing the prompt for the LLM based on a prompt technique comprises a chain-of-thought prompting process by:
training initially the LLM with an initial set of the plurality of stock market data up to a predetermined timepoint that prevents information leakage of the LLM;
generating tabular data of the plurality of stock market data based on the at least one financial news summary and the at least one of financial news summary sentiment for input into the LLM;
performing an in-context learning process for the LLM with the tabular data; and
conducting a chain-of-verification process for the LLM to check for hallucination by the LLM.

18. The method of claim 15, further comprising:
determining an accuracy of the generated prediction response based on computing a forward return for a company; and
comparing the forward return of the company with at least one respective forward return of at least one other company operating within a similar sector as represented by sector quintiles.

19. The method of claim 15, further comprising:
evaluating a performance of the LLM by computing a mean absolute error; and
adjusting the LLM by the fine-tuning of the LLM based on the evaluated performance.

20. The method of claim 15, wherein the LLM is trained with a dataset comprising a predetermined ratio of training data to validation data.
